(19) United States
(12) Patent Application Publication
(10) Pub. No.: US 2016/0308795 A1
(43) Pub. Date: Oct. 20, 2016

(54) METHOD, SYSTEM AND APPARATUS FOR CONFIGUING A CHATBOT

(71) Applicant: KIK INTERACTIVE INC., Waterloo (CA)

(72) Inventors: Pan Pan CHENG, Waterloo (CA); Marek GRZES, Waterloo (CA); Jesse HOEY, Waterloo (CA); Pascal POUPART, Waterloo (CA); Ricardo SALMON, Waterloo (CA); Yuriy BLOKHIN, Waterloo (CA); Aly VELLANI, Waterloo (CA)

(21) Appl. No.: 15/103,579

(22) PCT Filed: Dec. 12, 2014
(86) PCT No.: PCT/CA2014/000883

§ 371 Date: Jun. 10, 2016

Related U.S. Application Data
(60) Provisional application No. 61/915,760, filed on Dec. 13, 2013.

(51) Int. Cl. H04L 12/58; H04W 4/12

(52) U.S. Cl. CPC H04L 51/02; H04L 51/18; H04L 51/12; H04L 51/10; H04W 4/12

(57) ABSTRACT

According to embodiments described in the specification, a method, system and apparatus for configuring a chatbot application are provided. The method includes receiving a plurality of messages from a mobile computing device via a network, and storing the plurality of messages in a memory; identifying a plurality of clusters of related messages among the plurality of messages; presenting the clusters on a display; receiving a selection of one of the clusters, and receiving a class identifier for the selected cluster; retrieving a subset of the related messages corresponding to the selected cluster from the memory; deriving a plurality of attributes defining common characteristics of the subset; and storing the attributes and the class identifier.

### CROSS-REFERENCE TO RELATED APPLICATION

This application claims priority from U.S. Provisional Application No. 61/915,760, filed Dec. 13, 2013, the entire contents of which are incorporated herein by reference.

### FIELD

The specification relates generally to autonomous messaging applications (e.g. chatbots), and specifically to a method, system and apparatus for configuring a chatbot.

### BACKGROUND

Chatbots, also referred to as chatterbots, have grown in popularity in recent years. The capabilities and programmed behaviours of different chatbots vary depending on their intended audience—chatbots intended for entertainment purposes may employ different language processing and response algorithms than those intended to respond to customer service messages or complete Turing Tests. In general, however, chatbots can be configured to recognize various characteristics of messages they receive, and to respond to those messages differently depending on which characteristics were recognized in the received messages.

Extending the breadth of characteristics that a chatbot can recognize (and therefore respond to appropriately) can be highly time-intensive for administrators of the chatbots, and thus chatbots may respond slowly (or not at all) to newly emerging topics of conversation in incoming messages, and may require significant resources, including downtime, to accommodate new message characteristics.

### BRIEF DESCRIPTIONS OF THE DRAWINGS

Embodiments are described with reference to the following figures, in which:

FIG. 1 depicts a communications system, according to a non-limiting embodiment;

FIG. 2 depicts certain internal components of the computing devices of FIG. 1, according to a non-limiting embodiment;

FIG. 3 depicts a method for configuring a chatbot, according to a non-limiting embodiment; and

FIG. 4 depicts an interface produced by the application server of FIG. 1 during the performance of the method of FIG. 3, according to a non-limiting embodiment;

FIG. 5 depicts another interface produced by the application server of FIG. 1 during the performance of the method of FIG. 3, according to a non-limiting embodiment;

FIG. 6 depicts a further interface produced by the application server of FIG. 1 during the performance of the method of FIG. 3, according to a non-limiting embodiment;

FIG. 7 depicts a further interface produced by the application server of FIG. 1 during the performance of the method of FIG. 3, according to a non-limiting embodiment; and

FIG. 8 depicts a schematic representation of an application executed by the application server of FIG. 1, according to a non-limiting embodiment.

### DETAILED DESCRIPTION OF THE EMBODIMENTS

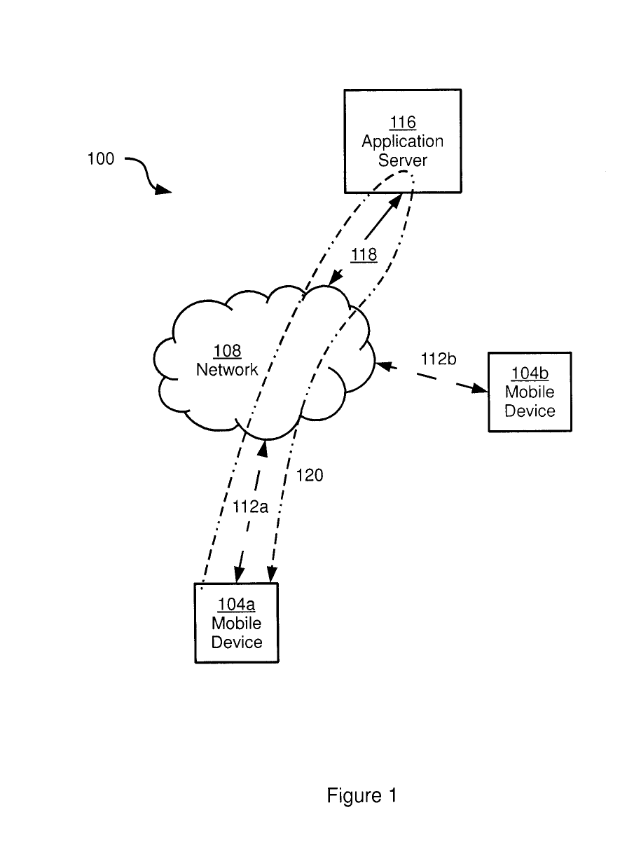

FIG. 1 depicts a communications system 100. System 100 includes a plurality of mobile computing devices, of which two examples 104a and 104b are shown (referred to generically as a mobile computing device 104, and collectively as mobile computing devices 104). Additional mobile computing devices (not shown) can be included in system 100. Each mobile computing device 104 can be any of a cellular phone, a smart phone, a tablet computer, and the like.

Mobile computing devices 104a and 104b are connected to a network 108 via respective links 112a and 112b, which are illustrated as wireless links but can also be wired links, or any suitable combination of wired and wireless links. Network 108 can include any suitable combination of wired and wireless networks, including but not limited to a Wide Area Network (WAN) such as the Internet, a Local Area Network (LAN) such as a corporate data network, cell phone networks, WiFi networks, WiMax networks and the like.

Via network 108, mobile computing devices 104 can communicate with an application server 116 connected to network 108 via a link 118. Application server 116 provides a messaging service to mobile computing devices 104. For example, mobile computing device 104a can execute a messaging application for sending and receiving messages to and from application server 116. Such messages can include instant messages (e.g. Internet Protocol-based messages), Short Message Service (SMS) messages, Multimedia Messaging Service (MMS) messages and the like. In this example, as shown by message path 120, mobile computing device 104a transmits a message to application server 116, and application server 116 generates and returns a response to mobile computing device 104a. In other words, application server 116 functions as a chatbot, autonomously carrying on a conversation with the user of mobile computing device 104a by automatically responding to messages received from mobile computing device 104a. In some embodiments, application server 116 can also route messages between mobile computing devices 104 (e.g. from mobile computing device 104a to mobile computing device 104b), however such embodiments are not discussed in detail herein.

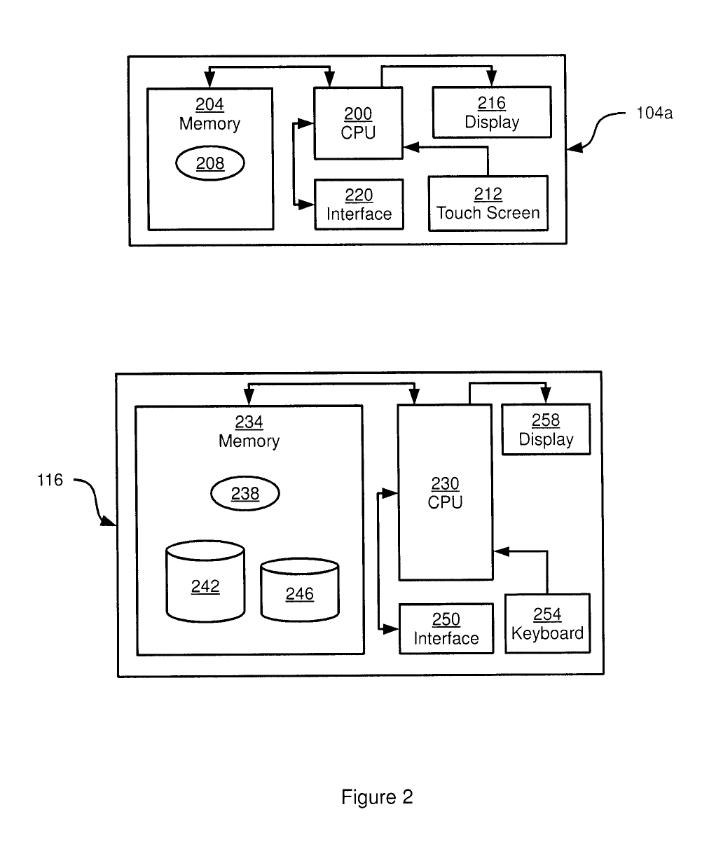

Before a detailed discussion of the operation of system 100 is provided, certain components of mobile computing device 104a and application server 116 will be described with reference to FIG. 2.

Referring now to FIG. 2, mobile computing device 104a includes a central processing unit (CPU) 200, also referred to herein as processor 200, interconnected with a memory 204. Memory 204 stores computer readable instructions executable by processor 200, including a messaging application 208. Processor 200 and memory 204 are generally comprised of one or more integrated circuits (ICs), and can have a variety of structures, as will now occur to those skilled in the art (for example, more than one CPU can be provided). Processor 200 executes the instructions of messaging application 208 to perform, in conjunction with the other components of mobile computing device 104a, various functions related to exchanging messages with application server 116. In the below discussion of those functions, mobile computing device 104a is said to be configured to perform those functions—it will be understood that mobile computing device 104a is so configured via the processing of the instructions in application 208 by the hardware components of mobile computing device 104a (including processor 200 and memory 204).

Mobile computing device 104a also includes input devices interconnected with processor 200, in the form of a touch screen 212. Mobile computing device 104a can also include other input devices, such as any suitable combination of a camera, a microphone, a GPS receiver, and the like (not shown). Mobile computing device 104a also includes output devices interconnected with processor 200, including a display 216 integrated with touch screen 212. Other output devices can also be provided, such as a speaker (not shown). Mobile computing device 104a also includes a network interface 220 interconnected with processor 200, which allows mobile computing device 104a to connect to network 108 via link 112a. Network interface 220 thus includes the necessary hardware, such as radio transmitter/receiver units, network interface controllers and the like, to communicate over link 112a.

Application server 116 includes a central processing unit (CPU) 230, also referred to herein as processor 230, interconnected with a memory 234. Memory 234 stores computer readable instructions executable by processor 230, including a chatbot application 238. Processor 230 and memory 234 are generally comprised of one or more integrated circuits (ICs), and can have a variety of structures, as will now occur to those skilled in the art (for example, more than one CPU can be provided). Processor 230 executes the instructions of chatbot application 238 to perform, in conjunction with the other components of application server 116, various functions related to receiving and responding to messages from mobile computing devices 104. In the discussion below of those functions, application server 116 is said to be configured to perform those functions—it will be understood that application server 116 is so configured via the processing of the instructions in application 238 by the hardware components of application server 116 (including processor 230 and memory 234).

Memory 234 also stores a message database 242, which contains messages received from mobile computing devices 104. Also stored in memory 234 is a classification database 246, which contains definitions of message classes, as well as predefined response messages for each message class. Message class definitions specify certain message characteristics, such as keywords, keyword frequencies, and the like.

Application server 116 also includes a network interface 250 interconnected with processor 230, which allows application server 116 to connect to network 108 via link 118. Network interface 250 thus includes the necessary hardware, such as network interface controllers and the like, to communicate over link 118. Application server 116 also includes input devices interconnected with processor 230, such as a keyboard 254, as well as output devices interconnected with processor 230, such as a display 258. Other input and output devices (e.g. a mouse, speakers) can also be connected to processor 230. In some embodiments (not shown), keyboard 254 and display 258 can be connected to processor 230 via network 108 and another computing device. In other words, keyboard 254 and display 258 can be local (as shown in FIG. 2) or remote.

As will be described in greater detail below, for each incoming message from a mobile computing device 104, application server 116 selects the class definition from database 246 that best fits the characteristics of that message, and then responds to that message with one of the predefined responses for the selected class. Classes can represent certain topics (e.g. pop culture, the weather, messages terminating a conversation). Predefined responses for each class are therefore geared towards the topic of the corresponding class. It will therefore be apparent to those skilled in the art that in order to broaden the range of messages that application server 116 can meaningfully respond to, classification database 246 may need to be extended with additional classes and response messages. In addition to classifying and responding to messages, application server 116 is also configured to automatically detect new classes within incoming messages, thus partially automating the process of extending classification database 246.

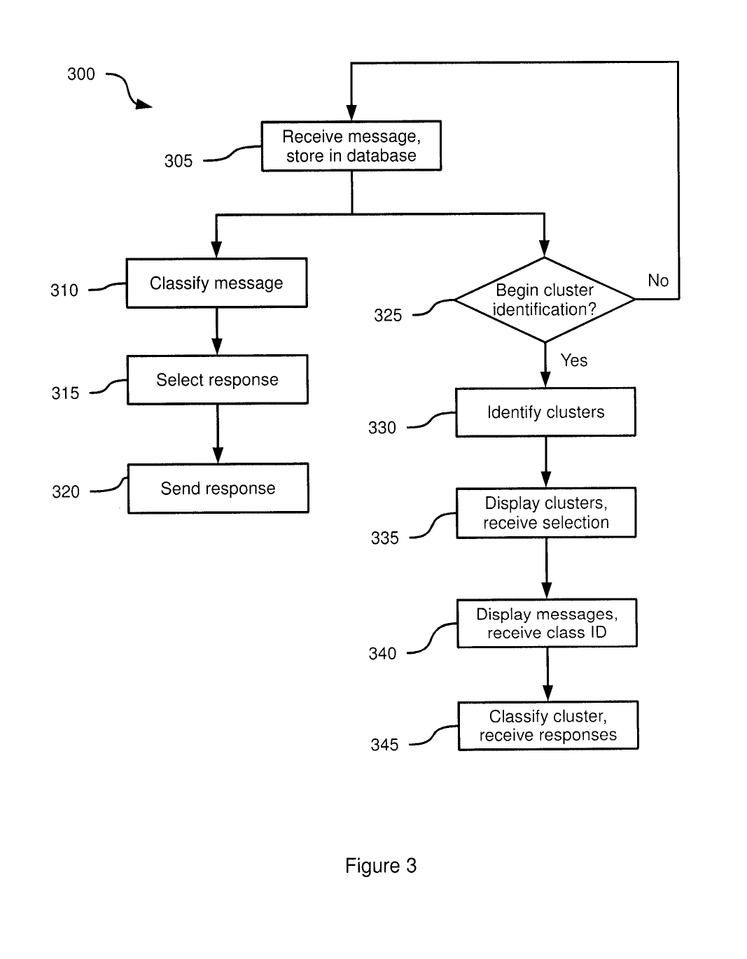

Referring now to FIG. 3, a method 300 of configuring a chatbot is shown. Method 300 will be described in connection with its performance on system 100, and specifically on application server 116, to process messages from mobile computing device 104a and automate the extension of classification database 246. It will be apparent to those skilled in the art, however, that method 300 can also be performed in variations of system 100.

Beginning at block 305, application server 116 is configured to receive a message from mobile computing device 104a, as shown in FIG. 1 (see message path 120). The received message is stored in message database 242 for further processing. Other data can be stored in database 242 in association with the received message, such as an originator identifier.

Server 116 can also perform various preprocessing tasks on the messages stored at block 305. For example, application server 116 can parse each message into a set of tokens. The tokens can be words (i.e. strings separated by “space” characters), sets of words (e.g. a sequence of two words). Application server 116 then normalizes the tokens to remove extraneous characters from words. For example, the token “nnnoooooo” is replaced with the word “no”. A set of configurable normalization rules can be stored in memory 234 defining which character removal or replacement operations are performed at this stage. The normalized tokens can also be passed through a spell-check process.

Having stored the received message, application server 116 is configured to take two courses of action. The two courses of action may be taken simultaneously, although there is no required temporal connection between them. The first course of action, classifying and responding to the message received at block 305, is shown in the left-hand branch of FIG. 3, while the second course of action is shown in the right-hand branch of FIG. 3.

At block 310, application server 116 is configured to classify the message received at block 305. Classification at block 310 may be performed in a variety of ways. In the present example, application 238 includes a classifier module which, when executed by processor 230, configures processor 230 to implement a Support Vector Machine (SVM) to compare the received message with each of the classes defined in classification database 246. In brief, classification database 246 includes, for each defined class, a class name and one or more class attributes defining common characteristics of messages in that class. To classify the received message using the SVM, application server 116 computes a score that the received message is a member of each defined class, based on how similar the content of the received message is to the attributes of each class defined in database 246. Application server 116 selects the class with the highest score. An identifier of the selected class (such as the class name) may be stored in association with the message in database 242, although this is not mandatory.

At block 315, application server 116 is configured to select a response for the message received at block 305. Database 246 contains a plurality of predefined responses in association with each class. Thus, at block 315, application server 116 selects one of the predefined response messages that is stored in association with the class selected at block 315. Thus, if the message was classified as a weather-related message (e.g. “I loathe the cold”), a response will be selected at block 315 from a pool of weather-related predefined responses (e.g. “Winter is my favourite season!”). In the present example, application server 116 is configured to select a response at random from the pool of responses for the selected class.

At block 320, application server 116 sends the selected response to mobile computing device 104a via network 108.

The second branch of method 300 may be performed simultaneously or separately from the first branch described above. At block 325, application server 116 is configured to determine whether to begin automatic cluster identification. In the present example, application server 116 is configured to perform cluster detection on batches of received messages. Thus, the determination at block 325 can include one or more of determining whether database 242 contains a sufficient number (e.g. over a predefined threshold) of new messages since the previous batch; whether a predefined time period between batches has elapsed since the previous batch; whether input data has been received from keyboard 254 or other input devices instructing application server 116 to begin batch processing.

When the determination at block 325 is negative, application server 116 is configured to return to block 305 and await the next incoming message. When the determination is affirmative, however, the performance of method 300 proceeds to block 330.

At block 330, application server 116 is configured to retrieve a batch of messages from database 242 according to any suitable criteria (e.g. messages arrived in a certain time period) and perform a cluster analysis on the retrieved messages. In the present example, application 238 includes a cluster analysis module that, when executed by processor 230, implements a naïve Bayes model, such as the algorithm described at the URL http://msdn.microsoft.com/en-us/magazine/jj991980.aspx, to group the retrieved messages into a plurality of clusters. The performance of block 330 can include receiving a predetermined number of clusters as input data, or can include the execution of a clustering algorithm for a range of cluster numbers to determine an optimal number of clusters by cross-validation. As will now be apparent to those skilled in the art, cross-validation refers to a general technique used in machine learning to automatically determine the best setting of some parameters (such as the number of clusters).

Other series of actions can also be performed by application server 116 to perform cluster analysis at block 330. In some embodiments, application server 116 implements cluster analysis via a sum product network.

A sum product network, as will be recognized by those skilled in the art, may be represented by a graph consisting of a plurality of end nodes, and a plurality of internal nodes connecting the end nodes (and other internal nodes), culminating in a root node. To perform cluster analysis using sum product networks, application server 116 is configured to generate the plurality of end nodes (also referred to as leaves) of the sum product network graph. Each end node represents a token from the messages retrieved from database 242. Thus, each node may represent a word contained in a message from database 242, and taken as a whole, the leaves of the sum product network contain every token in the messages retrieved from database 242.

Having generated the end nodes, application server 116 is configured to generate a plurality of internal nodes to connect the end nodes to each other (often via other internal nodes). The internal nodes consist of alternating layers of sum and product nodes. That is, an end node may be connected to a sum node, which in turn is connected to a product node (which may be connected to yet another sum node, and so on). The connections between nodes (referred to as edges) have weightings corresponding thereto, which are stored in memory 234. The number of internal nodes generated by application server 116, and the number of connections between those nodes, are not particularly limited, and will be determined by which particular sum product network algorithm is selected by the skilled person for implementation by application server 116.

In general, the sum product network represents a probability distribution over the tokens represented by the end nodes. The weightings assigned to edges (connections) between nodes indicate probabilities of certain tokens or groups of tokens appearing in sample messages. To generate the sum product network, application server 116 is configured to generate nodes and adjust weightings for the edges between nodes to maximize the probability of the messages retrieved at block 325 (that is, to maximize the likelihood of the sum product network recreating the original set of messages). Clusters may then be selected as all nodes (including leaves; i.e. a sub-tree) beneath a certain sum or product node. Alternatively, application server 116 can compute a vector for each message, corresponding to a combination of the weightings between nodes connected to the tokens of that message. Messages having sufficiently similar vectors may be clustered.

In addition, the sum product network is store in memory 234 for subsequent use at block 310. At block 310, when a sum product network is in use, the received message is classified by comparing the message to the stored sum product network. In particular, application server 116 is configured, based on the tokens in the message received at block 305, to either compute a vector as mentioned above, or determine whether those tokens fall within a sub-tree previously identified as a cluster.

Combinations of clustering processes are also contemplated, in what is referred to as an “ensemble learning technique”. For example, both SPN and naive Bayes clustering can be performed, with the results being combined by application server 116 to generate a final set of message clusters. The results of each process in a combination can also be weighted differently. Other models can also be employed at block 330, such as topic models, including latent Dirichlet allocation (LDA).

Once the batch of received messages has been arranged into clusters, application server 116 is configured to store cluster identifiers in any suitable manner. For example, a random string can be generated for each new cluster, and stored in database 242 in association with the messages forming that cluster. In another example, a separate database of processed message batches can be stored in memory 234, and the cluster identifiers can be stored in association with respective messages in that separate database. In still another example, identified clusters of messages can be stored in database 246. In general, the cluster identifiers are recorded in memory 234 in such a way as to allow for the later retrieval of the messages in each cluster.

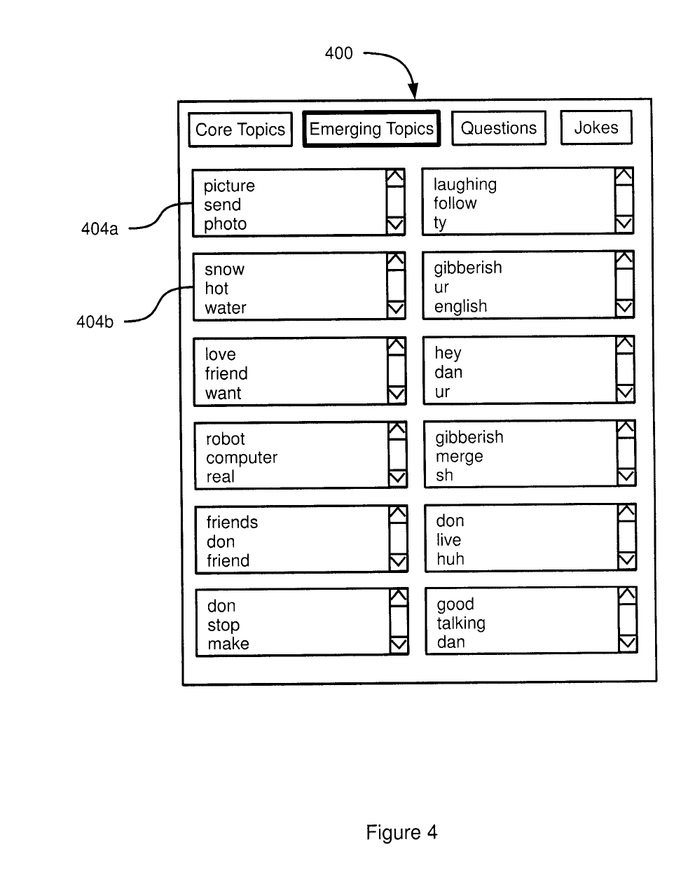

At block 335, application server 116 is configured to present at least one of the clusters identified at block 330 on display 258. For example, processor 230 can control display 258 to present an interface showing the clusters identified at block 330. Turning to FIG. 4, an example interface 400 generated at block 335 is shown. Interface 400 includes selectable elements 404a and 404b (other selectable elements are also shown, but not labelled for the sake of legibility), each corresponding to a cluster of related messages identified by application server 116. Each selectable element 404 includes indications of one or more attributes of the messages belonging to that cluster. Thus, the highlighted element (404a) indicates that a cluster of messages including the keywords “picture”, “send” and “photo” has been automatically identified. Keyboard 254 or other input devices connected to application server 116 can be manipulated by a user to provide input data to processor 230 selecting one of the elements 404 shown in FIG. 4.

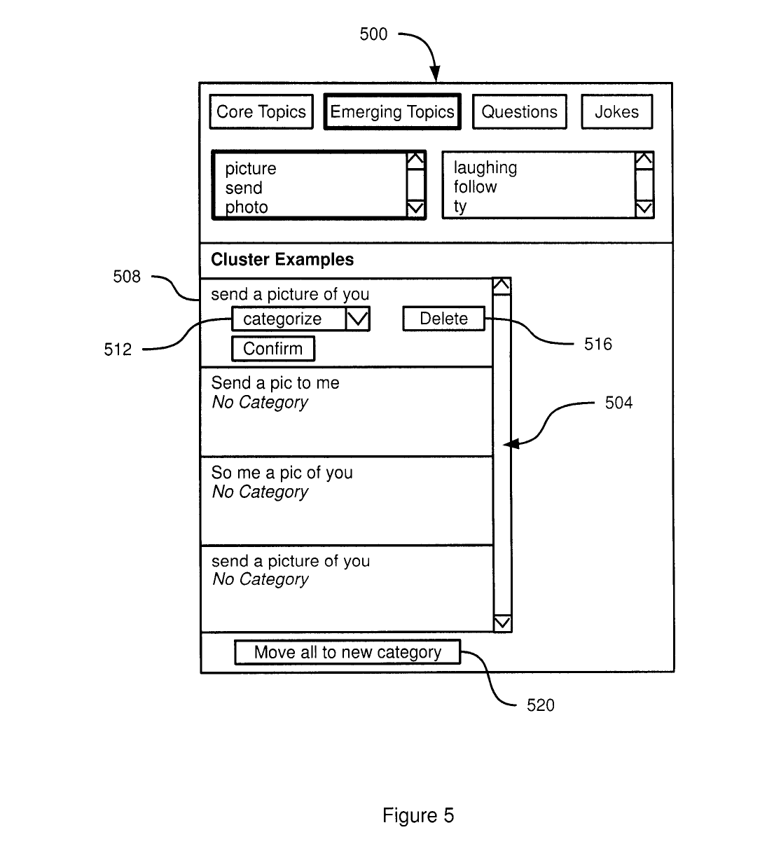

Returning to FIG. 3, after receiving a selection of an element 404 corresponding to a particular cluster at block 335, at block 340 application server 116 is configured to display the member messages of the selected cluster and to receive a class identifier for that cluster. Turning to FIG. 5, an interface 500 is shown, as presented by application server 116 upon selection of element 404a from FIG. 4. FIG. 5 includes a message pane 504 presenting one or more messages from the selected cluster. Thus, in performing block 340 application server 116 is configured to retrieve any messages from database 242 that are associated with the identifier of the cluster selected at block 335. Alternatively, if messages to be processed for clustering are copied to database 246, interface 500 can be produced by retrieving the relevant messages from database 246 rather than database 242. In some embodiments, duplicate messages within the cluster can be omitted from pane 504, and pane 504 can include an indication of how many times a displayed message is present in the cluster. Alternatively, the messages displayed in pane 504 can be arranged based on their frequency in the cluster, with the most often repeated message appearing at the top of pane 504.

Each message in pane 504 can be selected (a message 508 is shown as having been selected in FIG. 5). When a message has been selected, application server 116 updates interface 500 to display a selectable class menu 512 for that message. Class menu 512 is selectable to present a list (e.g. a drop-down list) of existing classes represented in database 246. Thus, application server 116 can receive input data associating message 508 with an existing class. The selected message is also provided with a selectable deletion element 516 for removing that message from the cluster (for example, if one of the messages in the cluster is topically unrelated to the remaining messages).

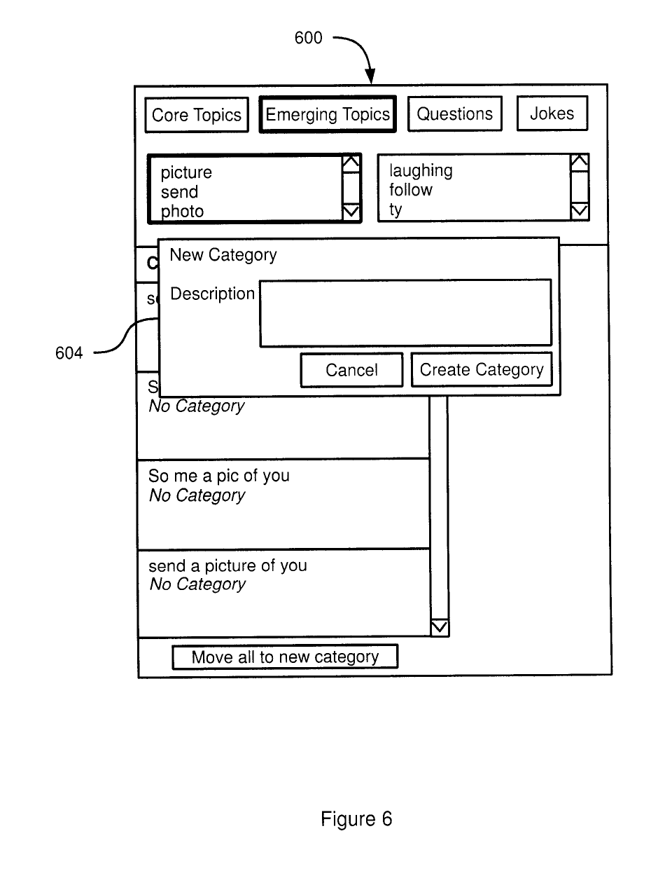

Also included in interface 500 is a selectable class creation element 520. When a selection of class creation element is received at processor 230 (via keyboard 254 or other input devices), application server 116 is configured to generate a prompt for a new class name or description. An example of such a prompt is shown in FIG. 6, in which an updated interface 600 is shown with a prompt 604 for receiving a class identifier (also referred to as a class description or a class name).

In some embodiments, interface 500 can also include additional selectable elements for appending additional identifiers to messages. For example, an emotion label (e.g. “happy”, “excited”, “sad”) can be applied to each message via another selectable element. Such labels can be independent of class identifiers and thus represent their own separate classes (in which case a message may be a member of two or more classes), or can be sub-class identifiers (in which case a message may be a member of a single class, but may also be assigned to a specific subset of that class).

Therefore, the performance of block 340 includes displaying messages in a selected class, optionally receiving input to manipulate the membership of the class (removing messages by deletion or assignment to an existing class), and receiving a class identifier. After application server 116 receives input data comprising the class identifier, the performance of method 300 proceeds to block 345.

At block 345, application server 116 is configured to process the messages in the cluster selected at block 335 using the classifier module mentioned earlier. Through the training process at block 345, application server 116 derives the attributes required to define the new class. In other words, the messages from the selected cluster are used as a training set to define the new class. The above-mentioned SVM (as well as other types of classifiers) has two modes: a classification mode (used to perform block 310) and a training mode (used to perform block 345). The classification mode corresponds to functionality described above in connection with block 310. The training mode is used when new messages have been assigned to existing classes, or when a new cluster has been selected from which to create a class. In the training mode, application server 116 is configured to execute an optimization algorithm to determine the best set of class attributes for the new class in order to reproduce the classification of the messages being used as a training set. In other words, the performance of block 345 involves determining the class attributes that, when applied to the cluster selected at block 335, correctly group all the messages in that cluster into the same class. In some embodiments, application server 116 can present an interface (not shown) including a selectable “train” element that can be used to initiate the training mode.

Also at block 345, application server 116 can be configured to execute an SVM to generate attributes for the sub-classes or other additional identifiers mentioned above, such as emotion labels. Thus, for example, at block 345 application server 116 may determine that repeated use of exclamation points correlates with the label “happy” and thus may store repeated exclamation points as an attribute for the “happy” label. In future performances of block 310, application server 116 is then able to not only classify messages, but also assign labels such as emotion identifiers to messages.

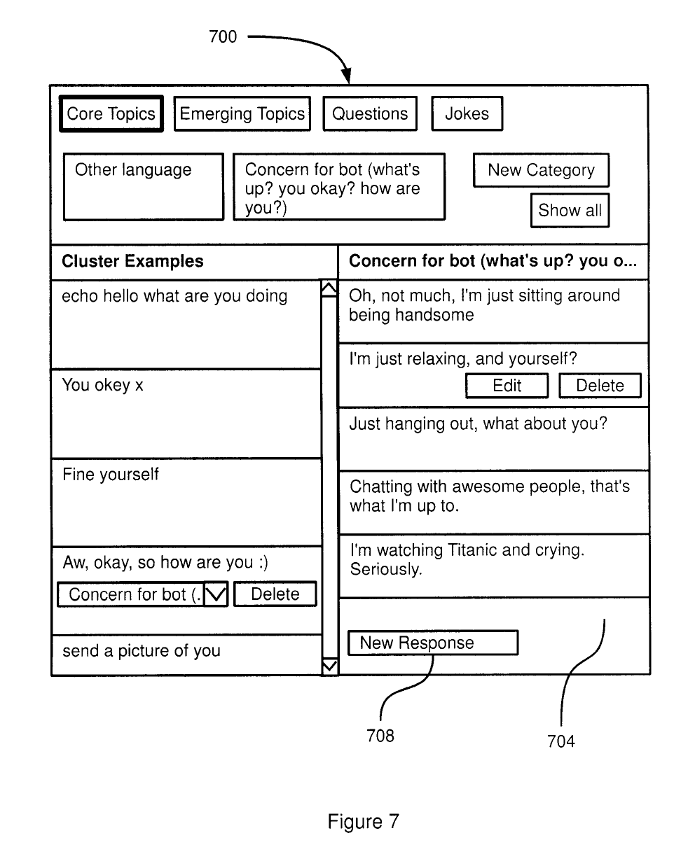

Having derived class attributes for the new class, application server 116 stores the attributes and the class identifier received at block 340 in database 246. In addition, processor 230 receives input data from keyboard 254 defining a plurality of response messages for the newly created class. Turning to FIG. 7, an interface 700 presented on display 258 includes a response pane 704 displaying the response messages currently saved in database 246. New responses are created by selecting a response creation element 708, after which application server 116 updates interface 700 to include a prompt for the new response message (not shown). Any responses created for the new class at block 345 are stored in database 246 in association with the new class. In embodiments where additional identifiers are applied to messages, such as emotional labels, additional subsets of responses can be received at block 345 corresponding to such additional identifiers. Thus, for example, ten responses can be received for a “sports” class, three of which also bear the “happy” label. each response can be received and stored corresponding to a single “input” message, or to an entire class of messages, or to a subset of a class. In some embodiment, responses can be received corresponding to messages from multiple classes (or subsets of multiple classes).

Once a new class has been created, another performance of method 300 can begin at block 305. Alternatively, the performance of method 300 can return directly to block 335, for example, to select another cluster for creating another new class. Additional performances of method 300 need not wait for the completion of a new class creation. For example, throughout one performance of blocks 325-345, blocks 305-310 can be performed numerous times. In addition, during the performance of blocks 335-345, blocks 305 and 325-330 can be repeated to identify additional clusters for later processing.

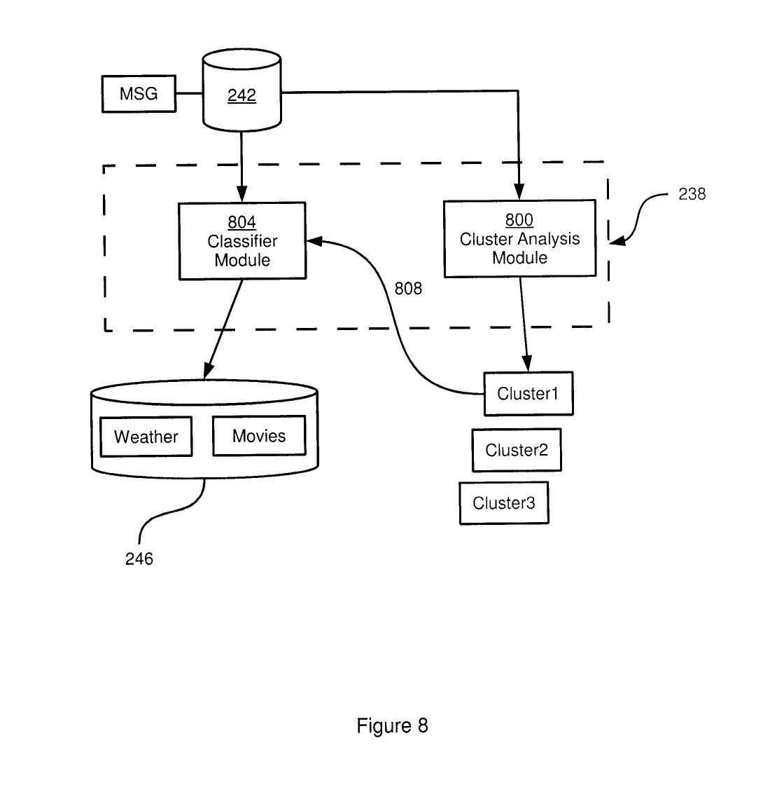

Although application 238 can be implemented on application server 116 in a variety of ways, referring to FIG. 8, an example implementation is shown. In particular, as mentioned above application 238 includes a cluster analysis module 800 and a classifier module 804. Incoming messages are stored in database 242, and accessed by both modules 800 and 804. Cluster analysis module 800 generates clusters (shown as “Cluster1”, “Cluster2” and “Cluster3”), and application 238 receives input selecting a cluster for use in creating a new class. The messages in that cluster are passed to classifier module 804 (see arrow 808), and classifier module 804 derives class attributes and stores those attributes, along with the received class identifier, in database 246 (along with existing classes, such as “weather” and “movies”).

Persons skilled in the art will appreciate that there are yet more alternative implementations and modifications possible for implementing the embodiments. For example, a variety of machine learning techniques can be used to implement the classification and cluster analysis described above, beyond SVM and naïve Bayes models. The scope, therefore, is only to be limited by the claims appended hereto.

A portion of the disclosure of this patent document contains material which is subject to copyright protection. The copyright owner has no objection to the facsimile reproduction by any one the patent document or patent disclosure, as it appears in patent office records, but otherwise reserves all copyrights.

We claim:

1. A method in an application server, comprising:
receiving a plurality of messages from a mobile computing device via a network, and storing the plurality of messages in a memory;
identifying a plurality of clusters of related messages among the plurality of messages;
presenting the clusters on a display;
receiving a selection of one of the clusters, and receiving a class identifier for the selected cluster;
retrieving a subset of the related messages corresponding to the selected cluster from the memory;
deriving a plurality of attributes defining common characteristics of the subset; and
storing the attributes and the class identifier.

2. The method of claim 1, further comprising:
prior to the identifying, determining whether to begin cluster identification.

3. The method of claim 2, wherein the determination is based on one or more of: a count of the plurality of messages; a period of time elapsed since a previous identification of clusters; and an instruction to begin cluster identification received from an input device.

4. The method of any one of claims 1 to 3, wherein identifying the plurality of clusters comprises processing the plurality of received messages by executing a clustering module.

5. The method of claim 4, wherein the clustering module is based on at least one of a naïve Bayes model and a sum product network.

6. The method of any one of claims 1 to 5, wherein deriving the plurality of attributes comprises processing the subset of the related messages by executing a classifier module.

7. The method of claim 6, wherein the classifier module is a Support Vector Machine (SVM).

8. The method of any one of claims 1 to 7, further comprising:
after storing the attributes and the class identifier, receiving a plurality of predefined responses corresponding to the attributes and the class identifier, and storing the responses in the memory.

9. The method of claim 8, further comprising:
receiving a subsequent message;
determining whether the subsequent message matches the attributes; and
when the determination is affirmative, selecting one of the predefined responses and transmitting the selected predefined response to the sender of the message.

10. An application server, comprising:
a memory;
a network interface; and
a processor interconnected with the memory and the network interface, the processor configured to execute the method of any one of claims 1 to 9.
